(19) United States
(12) Patent Application Publication
(10) Pub. No.: US 2010/0097806 A1
(43) Pub. Date: Apr. 22, 2010

(54) LED bulb arrangement

(76) Inventor: Hui-Lung Kao, Lu Chu Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,965

(22) Filed: Oct. 17, 2008

(51) Int. Cl. F21V 23/00; F21V 21/00

(52) U.S. Cl. 362/253; 362/368

(57) ABSTRACT

A LED (light-emitting diode) bulb arrangement, comprising: a) a plastic housing having an electric connection protrusion at the top thereof and an opening portion at the bottom thereof; b) a mounting base disposed within the plastic housing, LED being provided at the center thereof with light emitting in direction of the opening portion; c) a light-transmitting cover mounted at the opening portion of the plastic housing; and d) an LED drive circuit interposed between the mounting base and the electric connection protrusion within the plastic housing, one end thereof being coupled to the electric connection protrusion for conducting the modulation of the inputted direct current. In this way, the LED is driven under the low voltage and low current state according to the load property of the LED such that the plastic housing won't be overheated. As a result, a lightweight and power-saving cup-shaped LED lamp or LED bulb is created.

### BACKGROUND OF THE INVENTION

1. Field of the Invention

The invention relates to an LED (light-emitting diode) bulb arrangement, and more particularly to a cup-shaped LED lamp or an LED bulb that won't generate high temperature and is made of plastic material.

2. Description of the Related Art

With the upgrade the living standard, the light fittings will be more beautiful and practical when they are used in match with the interior decoration. As a result, cup-shaped LED lamps with atmospheric color temperature are often used.

As shown in FIG. 1, a conventional cup-shaped lamp 90 includes a main body 91 with an connection portion 92 at the top thereof. A halogen lamp 94 is installed within the main body 91. Two blades 93 are extended from the connection portion 92 for insertion into a plug socket (not shown) to establish an electric connection.

However, the halogen lamp 94 generates high temperature and has a high power consumption when it lights up. Moreover, the service life is short. These are the disadvantages of the halogen lamp 94. Therefore, the LED lamp was developed to replace the halogen lamp 94.

Nevertheless, only 15˜20% of the input power of high power LED is converted into light. The other 80˜85% thereof is converted into heat. If the generated heat is not properly handled and removed, it will cause high temperature of the LED chip, thereby influencing the wavelength. Even, the luminous efficiency will be affected and the service life will be reduced. Therefore, the heat generated by the system plays an important role for the function of the product. In resolving the problem of the heat removal, the internal heat conduction of the LED package and the heat dissipation design of the light fittings are generally first considered. Thus, great impacts upon the cost control of the package process and the restriction on volume and weight are created. Even, much trouble is caused. At present, there are few high-power LED light fittings in the market that are made of plastic material.

The application of the LED to the illumination is still not popular. The reason for that lies in that the heat-removal efficiency of the LED package is really limited. The high temperature must be created when the required operating voltage and current stay unchanged. Therefore, the expected effect is always hardly achieved by the packaging solution. Moreover, the light fittings are provided with heat-removal device such as cooling ribs that will increase the volume so as to complicate the indoor installation of the light fittings. In addition, the surface of the light fittings has still high temperature. For example, a table lamp employing LED as light source has a very hot surface. Meanwhile, the environment also becomes warmer. This will not only affect the use of the consumers, but also have a restriction that the light fittings must have a metal housing. Otherwise, the housing made of other material can't withstand the high temperature such that an undesired deformation takes place or even a dangerous burnout will happen. As a result, the whole structure requires further improvements.

### SUMMARY OF THE INVENTION

A primary object of the invention is to provide an LED bulb arrangement that includes a housing made of plastic material for reducing the weight of the whole lamp as well as for achieving an easy fabrication and a practical use. Meanwhile, the manufacturing cost is minimized such that the product can be widely accepted.

Another object of the invention is to provide an LED bulb arrangement that won't create high temperature such that a safer and power-saving use is ensured. Moreover, a prolonged service life thereof is achieved.

In order to achieve the above-mentioned objects, an LED bulb arrangement in accordance with the invention includes:

a) a plastic housing having an electric connection protrusion at the top thereof and an opening portion at the bottom thereof;

b) a mounting base disposed within the plastic housing, LED being provided at the center thereof with light emitting in direction of the opening portion;

c) a light-transmitting cover mounted at the opening portion of the plastic housing; and

d) an LED drive circuit interposed between the mounting base and the electric connection protrusion within the plastic housing, one end thereof being coupled to the electric connection protrusion for conducting the modulation of the inputted direct current,

whereby, according to the load property of the LED, the LED is driven under the low voltage and low current state such that the plastic housing won't be overheated.

### BRIEF DESCRIPTION OF THE DRAWINGS

The accomplishment of this and other objects of the invention will become apparent from the following descriptions and its accompanying figures of which:

FIG. 1 is a perspective view of a conventional cup-shaped lamp;

FIG. 2A is an exploded perspective view of an embodiment of the invention;

FIG. 2B is a perspective assembly view of the embodiment according to FIG. 2A;

FIG. 3 is a perspective view of the embodiment of the invention with a rectangular LED;

FIG. 4 is a perspective view of the embodiment of the invention with a circular LED;

FIG. 5 is a cross-sectional view of the rectangular LED secured to the cup-shaped LED lamp;

FIG. 6 is a cross-sectional view of the circular LED secured to the cup-shaped LED lamp;

FIG. 7 is an exploded perspective view of another embodiment of the invention;

FIG. 8 is a cutaway view of the assembled embodiment of FIG. 7;

FIG. 9 is a cutaway view of a further embodiment of the invention;

FIG. 10 is a cutaway view of still another embodiment of the invention;

FIG. 11 is a cutaway view of still a further embodiment of the invention; and

FIG. 12 is a block diagram of the LED drive circuit of the invention.

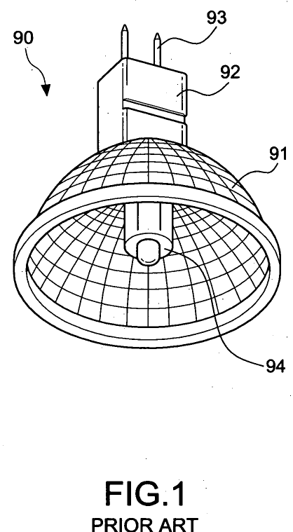

### DETAILED DESCRIPTION OF THE PREFERRED EMBODIMENT

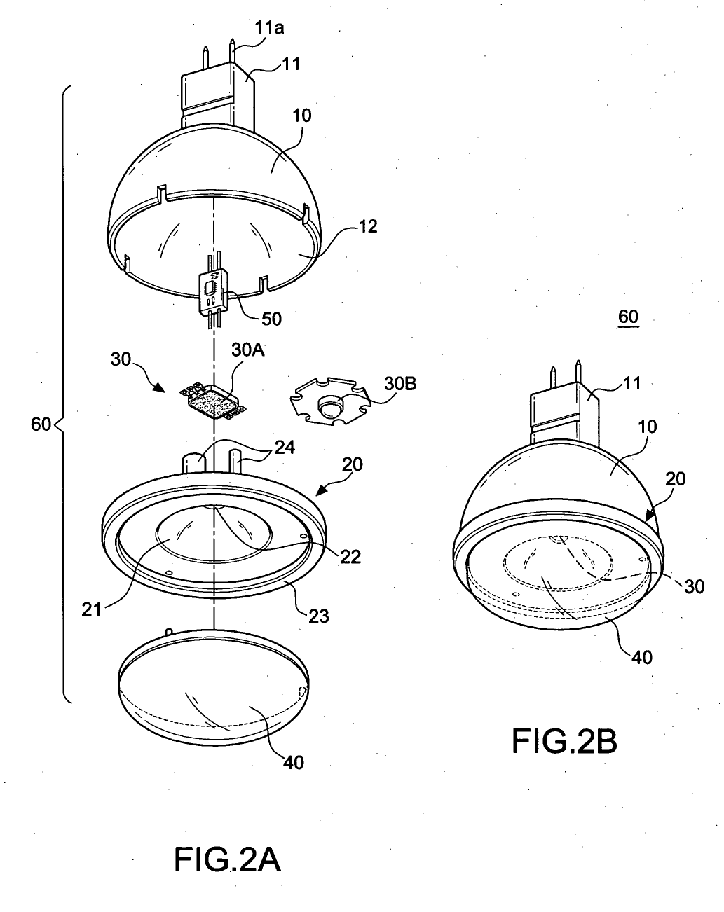

First of all, referring to FIGS. 2A, 2B and FIGS. 3 through 6, an applicable embodiment of an LED bulb arrangement in accordance with the invention includes a plastic housing 10, a mounting base 20, a light-transmitting cover 40, and an LED drive circuit 50.

In accordance with the embodiment, the plastic housing 10 is constructed as a conventional MR16 type cup-shaped lamp. An electric connection protrusion 11 is formed at the top thereof. Two blades 11a are provided at the top of the electric connection protrusion 11. An opening portion 12 is formed at the bottom thereof.

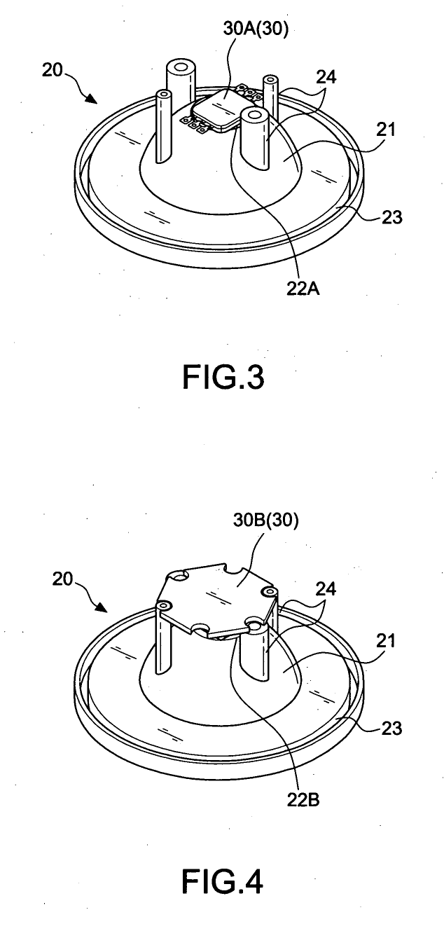

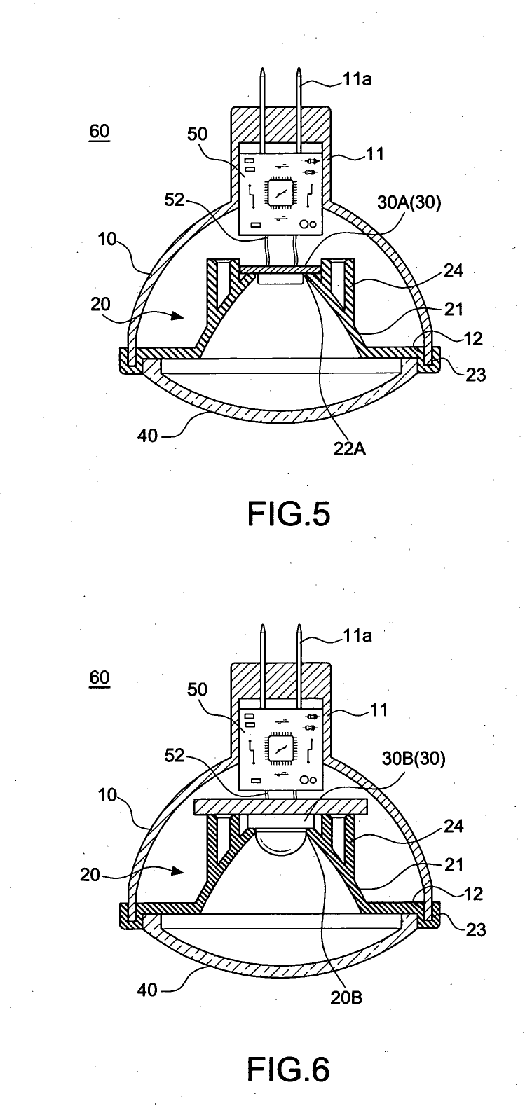

The mounting base 20 is disposed within the plastic housing 10. Moreover, the mounting base 20 includes a shade portion 21 with an downward opening formed at the center thereof. The shade portion 21 is made of plastic material by the injection molding process. A mounting hole 22 is formed at the top of the shade portion 21. The mounting hole 22 is made according to the shape of LED to be mounted. As shown in FIGS. 3 and 5, the mounting hole 22 is constructed as a rectangular hole 22A when a rectangular LED 30A is employed. As shown in FIGS. 4 and 6, the mounting hole 22 is constructed as a circular hole 22B when a circular LED 30B is employed. The above-mentioned LED is fixed by positioning posts 24 at the top of the shade portion 21 in place. Moreover, the mounting base 20 includes an annular groove 23 at the bottom rim thereof into which the opening portion 12 of the plastic housing 10 fits. In addition, the light of the LED is emitted in direction of the opening portion 12.

The light-transmitting cover 40 is disposed at the opening portion 12 of the plastic housing 10. According to the embodiment shown in FIGS. 5 and 6, the light-transmitting cover 40 is fixed at the internal wall of the annular groove 23 of the mounting base 20. According to the embodiment, the light-transmitting cover 40 fulfills the function of an optical lens in addition to the protection function.

The LED drive circuit 50 is interposed between the mounting base 20 and the electric connection protrusion 11 within the plastic housing 10. One end of the LED drive circuit 50 is coupled to the blades 11a of the electric connection protrusion 11 while the other end thereof is connected to the LED 30 via conducting wire 52. The LED drive circuit 50 is provided for modulating and processing the inputted direct current. According to the load property of the LED, the LED 30 is driven under the low voltage and low current state such that the plastic housing 10 won't be overheated.

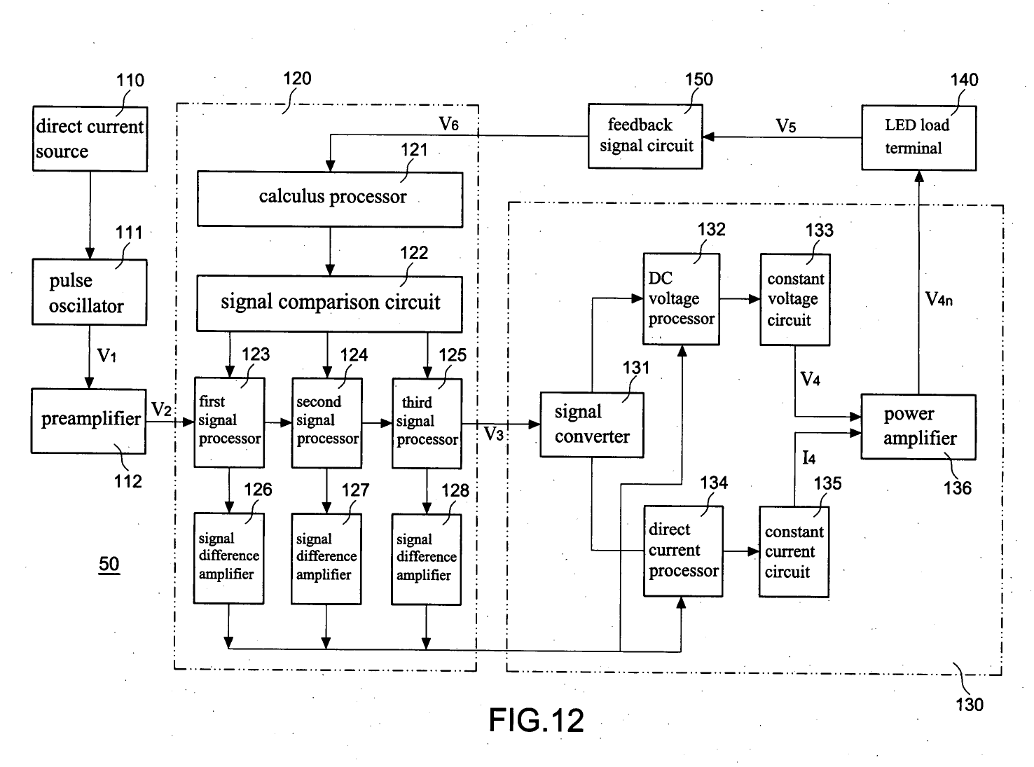

As shown in FIG. 12, the LED drive circuit according to a preferred embodiment of the invention includes a direct current source 110, a pulse oscillator 111, a preamplifier 112, a carrier signal modulating unit 120, a voltage/current-modulating unit 130, and a feedback signal circuit 150.

The direct current source 110 is adapted to supply the required power to an LED load terminal 140.

The pulse oscillator 111 is adapted to create a pulse signal voltage V1 by the current supplied by the direct current source 110.

The preamplifier 112 is coupled at the output terminal of the pulse oscillator 111 for amplifying the pulse signal voltage V1 to create an amplified signal voltage V2.

The carrier signal modulating unit 120 includes a calculus processor 121, a signal comparison circuit 122 coupled with the calculus processor 121, and at least three signal processors 123, 124, 125 coupled with the signal comparison circuit 122. The signal processors 123, 124, 125 are each coupled to a signal difference amplifier 126, 127, 128 for conducting at least three times of signal voltage comparison of the amplified signal voltage V2 so as to output a comparison signal voltage V3.

The voltage/current-modulating unit 130 includes a signal converter 131 for conducting a frequency conversion of the comparison signal voltage V3. After the processing thereof by a DC voltage processor 132, a constant voltage circuit 133, a direct current processor 134 and a constant current circuit 135, the constant voltage V4 and the constant current I4 are amplified by a power amplifier 136 and delivered to the LED load terminal 140.

The feedback signal circuit 150 is coupled between the LED load terminal 140 and the signal converter 131. A load signal voltage V5 is obtained at the LED load terminal 140. After feedback, a comparison signal voltage V6 is created and transmitted to an input terminal of the calculus processor 121. Thereafter, the signal processors 123, 124, 125 conduct at least three times of the software modulation process. Meanwhile, the attenuated signal voltage is automatically regulated, compensated, and amplified by the signal difference amplifiers 126, 127, 128 that are coupled to the DC voltage processor 132 and the direct current processor 134. In this way, the power amplifier 136 delivers a new operating voltage signal V4n to re-drive the LED load terminal 140. As a result, the LED load terminal 140 can be driven by the low voltage and low current through the above-mentioned modulation and correction process of the operating voltage signal. Thus, the heat dissipation temperature can be reduced.

According to the LED drive circuit 50 of the invention, the comparison signal voltage V6 is obtained at the LED load terminal 140 after feedback. The calculus processor 121 conducts an unceasing signal voltage comparison. Thereafter, at least three times of the software modulation process are done. Meanwhile, the attenuated signal voltage is automatically regulated, compensated, and amplified by the signal difference amplifiers 126, 127, 128. In this way, the voltage and the current can be corrected by the new operating voltage. After the empirical tests, the LED may be driven under a low current between 0.16 (DCA) and 0.18 (DCA), thereby maintaining the temperature at a range from 40° C. to 50° C. as well as 52° C. to 53° C., respectively. In this way, a high temperature can be avoided. In addition, the consumption power lies at about 2 W when the LED has a luminance of 350˜400 lux.

According to the LED bulb arrangement of the invention, the LED of high luminance and high power can be driven under the low voltage and low current state. Therefore, an energy-saving effect is achieved. Moreover, the heat dissipation problem can be resolved such that a cup-shaped LED lamp 60 may be created by the plastic housing 10 and an additional heat-removal device is not required. Consequently, the volume thereof can be maintained at an original level such that it can be matched with the conventional cup-shaped lamp plug socket. A replacement of the whole set is not necessary. Thus, it is very practical and convenient.

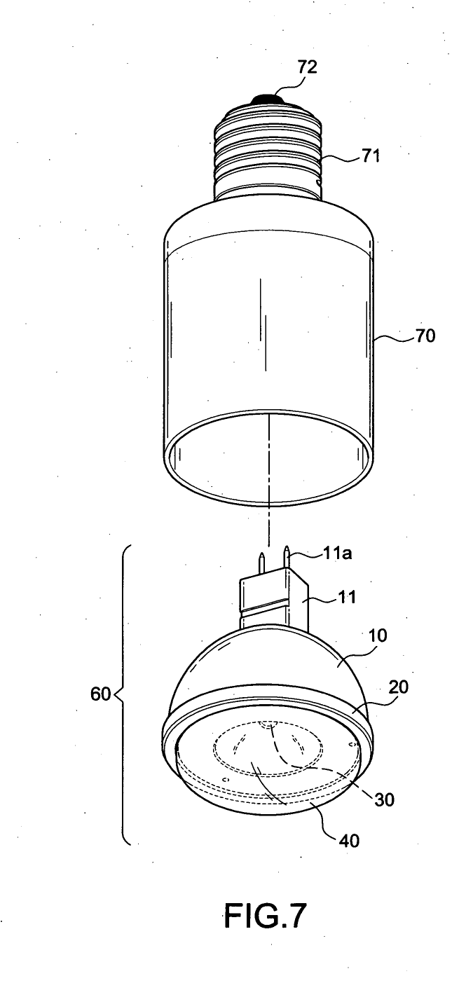

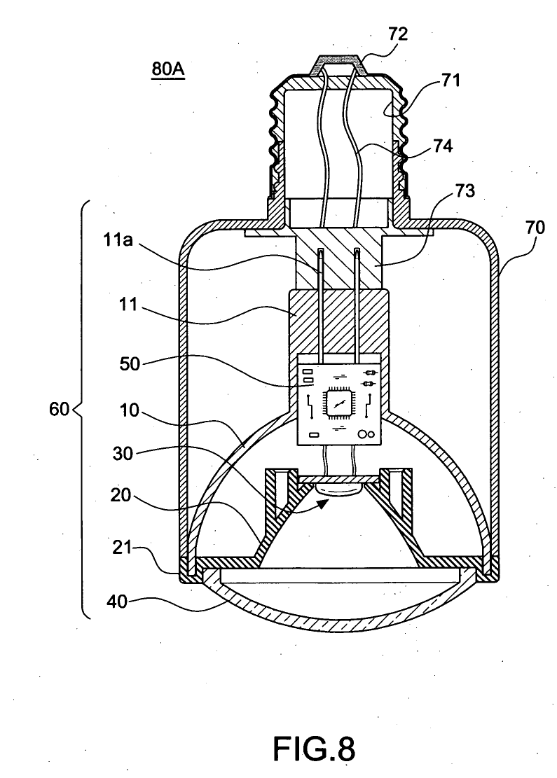

FIGS. 7 and 8 illustrate another embodiment of the invention. The above-mentioned cup-shaped LED lamp 60 is connected with a cylindrical housing 70 having a shape of light bulb. The cylindrical housing 70 includes a hollow body with an opening directed downward. A screwed head 71 and a contact terminal 72 are formed at the top thereof. A set of conducting wire 74 is disposed within the cylindrical housing 70 such that the contact terminal 72 is electrically connected to a plug socket 73 into which two blades 11a at the top of the plastic housing 10 fit. The annular groove 23 of the mounting base 20 is located at the opening of the cylindrical housing 70. Based on the above-mentioned configuration, a LED bulb 80A with a screwed head 71 is created. This structure has the advantage of the individual use of the cup-shaped LED lamp 60. Meanwhile, the cup-shaped LED lamp 60 can be readily attached to the cylindrical housing 70 to create an ordinary light-bulb type structure for an easy threaded connection to a conventional bulb socket. In this way, the conventional indoor lighting fitting can achieve the LED illumination effect without a laborious replacement of the whole unit.

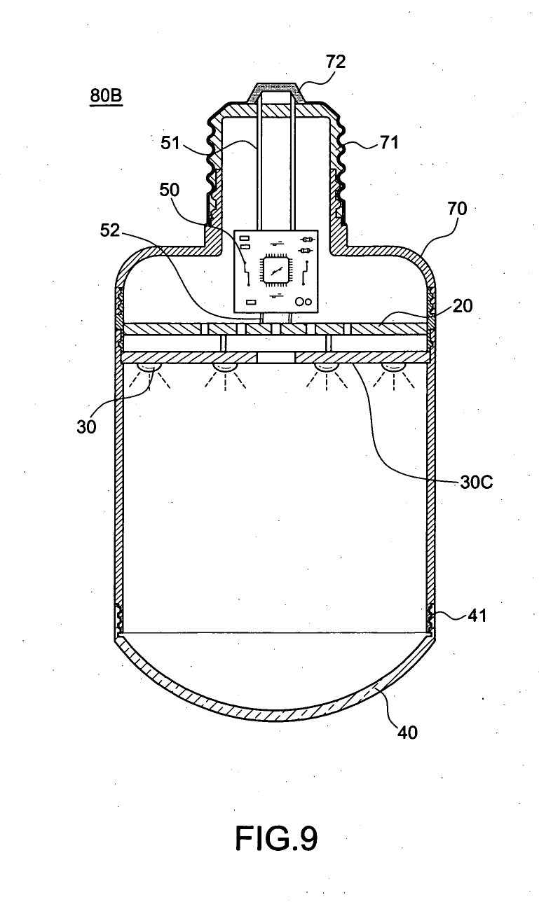

FIG. 9 shows another embodiment of the invention. The plastic housing 10 is made in a shape the same as the cylindrical housing 70. An electric screwed head 71 is formed at the top thereof. The mounting base 20 is made in a circular shape. A circuit board 30C having a plurality of LEDs 30 is positioned at the bottom surface thereof. The light-transmitting cover 40 is screwed to the opening portion of the cylindrical housing 70 by means of a threaded portion 41. Based on the above-mentioned configuration, a LED bulb 80B with a screwed head 71 is created. The external structure is similar to the LED bulb 80A in FIG. 8. The difference lies in that the cup-shaped LED lamp 60 is directly integrated within the cylindrical housing 70. The top of the LED drive circuit 50 is connected to the contact terminal 72 via conducting wire 51 while the bottom end thereof is connected to the LED circuit board 30C via conducting wire 52.

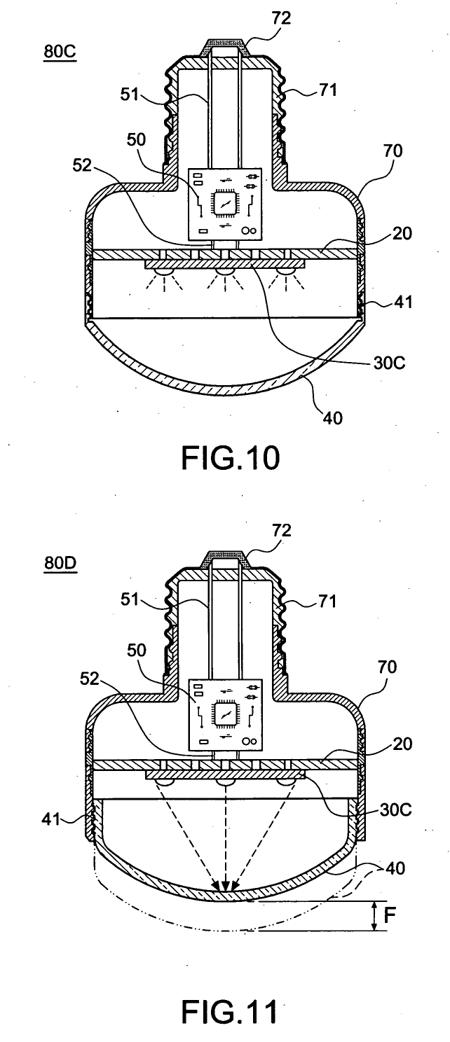

FIG. 10 shows a further embodiment of the invention that has the same structure as the above-mentioned embodiments. The same elements are marked with the same reference signs. The difference lies in that the cylindrical housing 70 is shorter than the cylindrical housing 70 in FIG. 9. In other words, the plastic housing 10 may be made in the shape of a long cylindrical housing or a short cylindrical housing.

FIG. 11 shows still another embodiment of the invention. The light-transmitting cover 40 is screwed at the opening portion of the cylindrical housing 70 via a threaded portion 41. As shown by the dashed line, the height of the light-transmitting cover 40 is adjustable for adjusting the LED focal length F so as to achieve an optimal effect.

Unlike the conventional halogen lamp, the LED bulb, or the cup-shaped LED lamp employing a metal housing, the above-mentioned embodiments are all created by the plastic housing 10 in match of the LED drive circuit 50. Therefore, a power-saving and environment-protecting effect may be achieved. Moreover, the cost may be reduced for a popular use.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An LED (light-emitting diode) bulb arrangement, comprising:
a) a plastic housing having an electric connection protrusion at the top thereof and an opening portion at the bottom thereof;
b) a mounting base disposed within the plastic housing, LED being provided at the center thereof with light emitting in direction of the opening portion;
c) a light-transmitting cover mounted at the opening portion of the plastic housing; and
d) an LED drive circuit interposed between the mounting base and the electric connection protrusion within the plastic housing, one end thereof being coupled to the electric connection protrusion for conducting the modulation of the inputted direct current,
whereby, according to the load property of the LED, the LED is driven under the low voltage and low current state such that the plastic housing won't be overheated.

2. The LED bulb arrangement as recited in claim 1 wherein the LED drive circuit includes:
a direct current source adapted to supply the required power to an LED load terminal;
a pulse oscillator adapted to create a pulse signal voltage V1 by the current supplied by the direct current source;
a preamplifier coupled at the output terminal of the pulse oscillator for amplifying the pulse signal voltage V1 to create an amplified signal voltage V2;
a carrier signal modulating unit having a calculus processor, a signal comparison circuit coupled with the calculus processor, and at least three signal processors coupled with the signal comparison circuit, the signal processors each being coupled to a signal difference amplifier for conducting at least three times of signal voltage comparison of the amplified signal voltage V2 so as to output a comparison signal voltage V3;
a voltage/current-modulating unit having a signal converter for conducting a frequency conversion of the comparison signal voltage V3, wherein, after the processing thereof by a DC voltage processor, a constant voltage circuit, a direct current processor and a constant current circuit, the constant voltage V4 and the constant current I4 are amplified by a power amplifier and delivered to the LED load terminal; and
a feedback signal circuit coupled between the LED load terminal and the signal converter, a load signal voltage V5 being obtained at the LED load terminal, wherein, after feedback, a comparison signal voltage V6 is created and transmitted to an input terminal of the calculus processor whereupon the signal processors conduct at least three times of the software modulation process, and wherein the attenuated signal voltage is automatically regulated, compensated, and amplified by the signal difference amplifiers that are coupled to the DC voltage processor and the direct current processor; as a result, the power amplifier delivers a new operating voltage signal V4n to re-drive the LED load terminal such that the LED load terminal can be driven by the low voltage and low current through the above-mentioned modulation and correction process of the operating voltage signal, thereby reducing the heat dissipation temperature.

3. The LED bulb arrangement as recited in claim 1 wherein the plastic housing is constructed as a MR16 type cup-shaped lamp, and wherein an electric connection protrusion is formed at the top thereof, and wherein two blades are provided at the top of the electric connection protrusion.

4. The LED bulb arrangement as recited in claim 3 wherein the mounting base includes a shade portion with an downward opening formed at the center thereof, and the shade portion is made of plastic material, and a mounting hole is formed at the top of the shade portion, and the mounting hole is made in a rectangular or circular shape according to the shape of LED, and wherein the mounting base includes an annular groove at the bottom rim thereof into which the opening portion of the plastic housing fits.

5. The LED bulb arrangement as recited in claim 4 wherein the light-transmitting cover is fixed at the internal wall of the annular groove of the mounting base.

6. The LED bulb arrangement as recited in claim 5 wherein the plastic housing is connected with a cylindrical housing having a hollow body with an opening directed downward, and wherein a screwed head and a contact terminal are formed at the top thereof, and wherein the contact terminal is electrically connected to a plug socket into which two blades at the top of the plastic housing fit, and wherein the annular groove of the mounting base is located at the opening of the cylindrical housing whereby an LED bulb with a screwed head is created.

7. The LED bulb arrangement as recited in claim 2 wherein the plastic housing is constructed as a cylindrical housing while the electric connection protrusion is formed as a screwed head, and wherein the mounting base is made in a circular shape, and wherein a circuit board having a plurality of LEDs is positioned at the bottom surface thereof, and wherein the light-transmitting cover is screwed to the opening portion of the cylindrical housing by means of a threaded portion, whereby an LED bulb with a screwed head is created.

8. The LED bulb arrangement as recited in claim 7 wherein the plastic housing is made in the shape of a long cylindrical housing or a short cylindrical housing.

9. The LED bulb arrangement as recited in claim 8 wherein, the height of the light-transmitting cover at the opening portion of the plastic housing is adjustable for adjusting the LED focal length.
